(19) United States
(12) Patent Application Publication
(10) Pub. No.: US 2006/0280531 A1
(43) Pub. Date: Dec. 14, 2006

(54) Transfer-detack assembly for a xerographic printer

(75) Inventors: John R. Washington, Bedfordshire (GB); Derek W. Judd, Hertfordshire (GB)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/149,747

(22) Filed: Jun. 10, 2005

(51) Int. Cl. G03G 15/16

(52) U.S. Cl. 399/311

(57) ABSTRACT

An apparatus applies a charge to an imaging member, such as a photoreceptor in a xerographic printer. A shield is disposed to be operatively interposed between a non-imaging portion of the imaging member and a portion of the corona member, the shield being at least partially conductive, and in one embodiment, grounded. The shield prevents the accumulation of stray toner particles.

### TECHNICAL FIELD

The present disclosure relates to a transfer-detack apparatus as is known in electrostatography or xerography.

### BACKGROUND

The basic principles of electrostatographic printing with dry marking material (hereinafter generally referred to as xerography) are well known: an electrostatic latent image is created on a charge-retentive surface, such as a photoreceptor or other charge receptor, and the latent image is developed by exposing it to a supply of toner particles, which are attracted as needed to appropriately-charged areas of the latent image. The toner particles are then transferred in imagewise fashion from the photoreceptor to a print sheet, the print sheet being subsequently heated to permanently fuse the toner particles thereto to form a durable image.

The suitably charged areas on the photoreceptor surface are developed with fine toner particles, creating an image with the toner which is transferred to a print sheet, which is typically a sheet of paper but which could conceivably be any kind of substrate. This transfer is typically carried out by the creation of a “transfer-detack zone” (often abbreviated to just “transfer zone”) of AC and DC biases where the print sheet is in contact with, or otherwise proximate to, the photoreceptor. A DC bias applied to the back (i.e. on the face away from the photoreceptor) of the paper or other substrate in the transfer zone electrostatically transfers the toner from the photoreceptor to the paper or other substrate presented to the transfer zone.

The present disclosure relates to overcoming a problem with stray toner particles spreading through a xerographic printing module or machine, causing undesired marking on a print sheet passing through the transfer zone.

### SUMMARY

According to one aspect, there is provided an apparatus for applying a charge to an imaging member, the imaging member being rotatable along a process direction. At least one corona member extends perpendicular to the process direction. A shield is disposed to be operatively interposed between a non-imaging portion of the imaging member and a portion of the corona member, the shield being at least partially conductive.

According to another aspect, there is provided a printing apparatus, comprising an imaging member, rotatable along a process direction. At least one corona member extends perpendicular to the process direction. A shield is interposed between a non-imaging portion of the imaging member and a portion of the corona member, the shield being at least partially conductive.

### BRIEF DESCRIPTION OF THE DRAWINGS

FIG. 1 is a simplified elevational view, and FIG. 2 is a partially exploded perspective view, showing relevant elements of an electrostatographic or xerographic printing apparatus.

FIG. 3 is a partial exploded view of one end of a transfer-detack assembly in an electrostatographic or xerographic printing apparatus.

### DETAILED DESCRIPTION

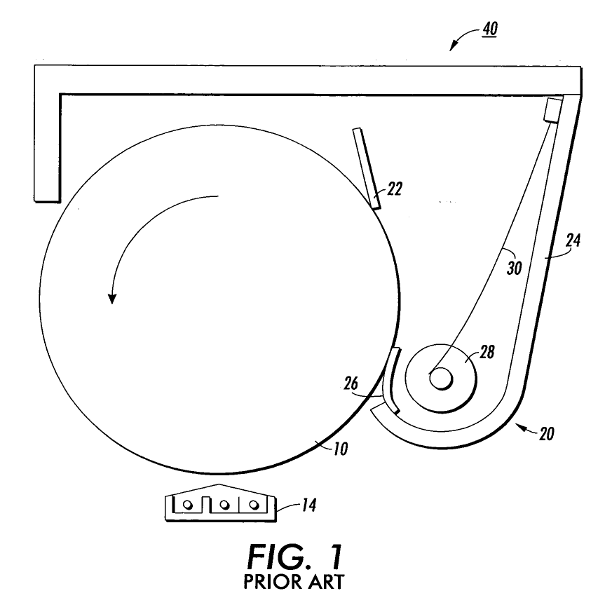

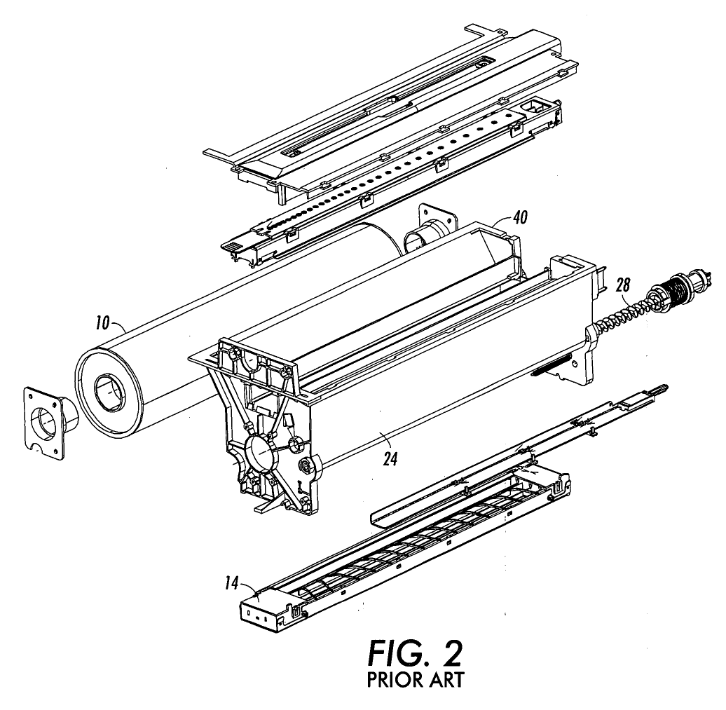

FIG. 1 is a simplified elevational view, and FIG. 2 is a partially exploded perspective view, showing relevant elements of an electrostatographic or xerographic printing apparatus, many of which are disposed within a module housing generally shown as 100, and which may in turn be installed in a larger printing machine. As is well known, an electrostatic latent image is created, by means not shown, on a surface of an imaging member such as photoreceptor 10. The latent image is developed by applying thereto a supply of toner particles, such as with a developer roll (not shown), which may be of any of various designs such as a magnetic brush roll or donor roll, as is familiar in the art. The toner particles adhere to the appropriately-charged areas of the latent image. The surface of photoreceptor 10 then moves, as shown by the arrow, to a transfer zone created by a transfer-detack assembly generally indicated as 14. Simultaneously, a print sheet on which a desired image is to be printed is conveyed to the transfer zone as well.

At the transfer zone, the print sheet is brought into contact or at least proximity with a surface of photoreceptor 10, which at this point is carrying toner particles thereon. A corotron or other charge source in assembly 14 causes the toner on photoreceptor 10 to be electrically transferred to the print sheet. The print sheet is then sent to subsequent stations, as is familiar in the art, such as a fuser and finishing devices (not shown).

Following transfer of most of the toner particles to the print sheet in the transfer zone, any residual toner particles remaining on the surface of photoreceptor 10 are removed at a cleaning station, which is generally indicated as 20. A cleaning blade 22 is urged against the surface of photoreceptor 10 and scrapes the residual toner off the surface. The toner which is thus removed falls downward into a hopper 24 formed in housing 100 for accumulating the toner. A flexible flap seal 26, extending the length of the photoreceptor 10, prevents loose toner from escaping the hopper.

At the bottom of the hopper is an auger 28, shown end-on in the view of FIG. 1, and shown partially removed in the view of FIG. 2. The auger extends substantially the length of the photoreceptor 10. The auger 28 is rotated and thus conveys toner particles at the bottom of the hopper to some sort of waste container (not shown). An agitator 30, made of a thin, flexible material, can interact with the auger to clean the flights of the auger.

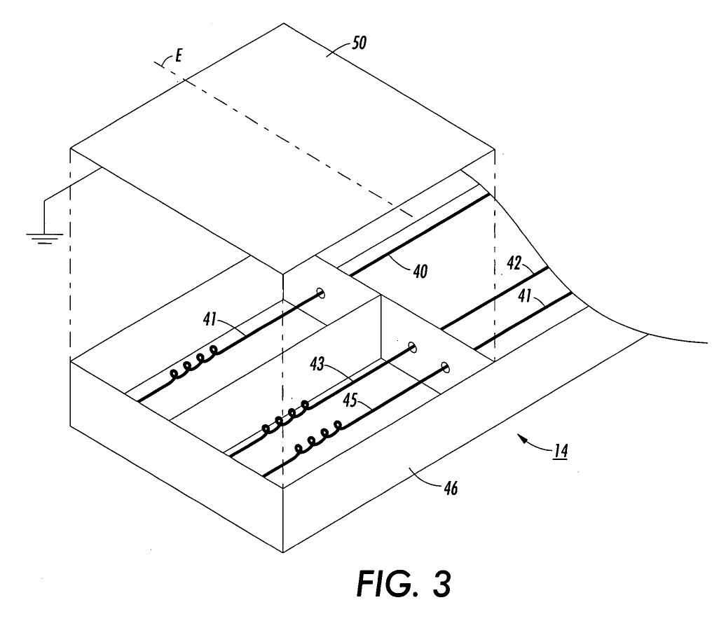

FIG. 3 is a partial exploded view of one end of the transfer-detack assembly 14. In this embodiment, assembly 14 includes one transfer wire 40, and two detack wires 42, 44, although other types of corona members, such as conductive bands with or without saw-teeth forming pin arrays, are generally known. The wires 40, 42, 44 extend the length of photoreceptor 10. At at least one end of each wire there is a mounting, which may include a spring such as 41, 43, 45. In this embodiment, the end mountings of the wires are disposed within a small enclosure 46, which largely prevents stray particles from coming into contact with the mountings.

Covering the end mountings of the wires 40, 42, 44 and the enclosure 46 is a cover 50. The cover 50 is disposed relative to photoreceptor 10 in the complete module so that one edge of photoreceptor 10 crosses the cover, such as shown by edge line E in FIG. 3; as such, the cover 50 is interposed between the wires 42, 44, 46 and a non-imaging portion at the end of rotatable photoreceptor 10. Cover 50 is made of a conductive material, such as metal or conductive plastic. In the embodiment, the cover is grounded, as shown. The grounding can be effected by contacting the cover 50 to a grounded contact in the machine in which the module 100 is installed. Cover 50 thus acts as a shield interposed between a non-imaging portion of the photoreceptor 10 and a portion of the corona member such as any wire 42, 44, 46.

By grounding the cover 50, stray charged toner particles from the development of an electrostatic latent image on photoreceptor 10 will not accumulate at the edge of photoreceptor 10, and possibly attach to sheets passing through the transfer zone. Effectively the cover 50 works to shield the fields created by the transfer wires below the cover 50 from the overlapping portion of the photoreceptor 10 above the cover 50. The cover 50 is particularly useful if the transfer assembly is disposed substantially near the bottom of the rotating image member, where stray particles are likely to fall, particularly if the area around the cover 50 is exposed during jam clearance or other maintenance, or when a module such as 100 is removed for replacement.

In one practical embodiment of a printer without the cover such as 50, a positive charging of the photoreceptor can occur in the area near the ends of wires 42, 44, 46; this positive-charged “band” at the end of photoreceptor 10 can then attract negatively-charged toner particles elsewhere in the printing process with each rotation of photoreceptor 10, leading to a defect in resulting prints. The conductive or grounded cover 50 prevents any positive charging of the photoreceptor in the overlapping area, and thus obviates this type of print defect.

In the embodiment, the cover 50 is grounded as shown, but it is also possible that the cover 50 be biased to some predetermined polarity and potential. The bias would typically be supplied through a contact in the machine in which the module 100 is installed. Such a bias can be selected for most effective use in a particular machine design.

Although the illustrated embodiment is shown in the transfer zone of a xerographic printing apparatus, the shield or cover such as 50 can be employed at any location where a charge is applied to an imaging member, such as a charging or cleaning station. Also, although the illustrated embodiment is shown with a photoreceptor of a xerographic printing apparatus, the shield or cover such as 50 can be employed with other types of imaging member, such as an intermediate transfer belt, as would be used in color xerography.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. An apparatus for applying a charge to an imaging member, the imaging member being rotatable along a process direction, comprising:
at least one corona member extending perpendicular to the process direction;
a shield disposed to be operatively interposed between a non-imaging portion of the imaging member and a portion of the corona member, the shield being at least partially conductive.

2. The apparatus of claim 1, the shield being grounded when the apparatus is installed in a printing machine.

3. The apparatus of claim 1, the shield being disposed to be located near an end of the imaging member when the apparatus is installed in a printing machine.

4. The apparatus of claim 1, the shield being crossed by an edge of a rotatable image member when the apparatus is installed in a printing machine.

5. The apparatus of claim 1, the shield being disposed substantially near a bottom of the imaging member when the apparatus is installed in a printing machine.

6. The apparatus of claim 1, further comprising:
a second corona member, extending perpendicular to the process direction.

7. The apparatus of claim 1, a portion of the corona member being substantially enclosed in an enclosure.

8. The apparatus of claim 1, further comprising
a rotatable imaging member.

9. The apparatus of claim 1, wherein the corona member is associated with a transfer zone.

10. A printing apparatus, comprising:
an imaging member, the imaging member being rotatable along a process direction;
at least one corona member extending perpendicular to the process direction;
a shield interposed between a non-imaging portion of the imaging member and a portion of the corona member, the shield being at least partially conductive.

11. The apparatus of claim 10, the printing apparatus being a module installable within a larger printing machine.

12. The apparatus of claim 10, the shield being grounded.

13. The apparatus of claim 10, the shield being disposed to be located near an end of the imaging member.

14. The apparatus of claim 10, the shield being crossed by an edge of the image member.

15. The apparatus of claim 10, the corona member including a wire.

16. The apparatus of claim 10, further comprising:
a second corona member, extending perpendicular to the process direction.

17. The apparatus of claim 10, a portion of the corona member being substantially enclosed in an enclosure.

18. The apparatus of claim 10, wherein the corona member is associated with a transfer zone.

19. The apparatus of claim 10, wherein the imaging member is a photoreceptor.

20. The apparatus of claim 10, the shield being disposed substantially near a bottom of the imaging member.
